(19) United States
(12) Patent Application Publication
(10) Pub. No.: US 2024/0278540 A1
(43) Pub. Date: Aug. 22, 2024

(54) GLASS PLATE, VEHICULAR WINDOW GLASS, AND LAMINATED GLASS

(71) Applicant: AGC Inc., Tokyo (JP)

(72) Inventors: Shigeki SAWAMURA, Tokyo (JP); Takato KAJIHARA, Tokyo (JP)

(73) Assignee: AGC Inc., Tokyo (JP)

(21) Appl. No.: 18/647,083

(22) Filed: Apr. 26, 2024

Related U.S. Application Data
(63) Continuation of application No. PCT/JP2022/039575, filed on Oct. 24, 2022.

(30) Foreign Application Priority Data
Oct. 27, 2021 (JP) 2021-175914

(51) Int. Cl. B32B 17/10; B60J 1/00; C03C 3/087; C03C 3/091

(52) U.S. Cl. CPC B32B 17/10119; B32B 17/10036; B32B 17/101; B32B 17/10449; B32B 17/10761; B60J 1/001; C03C 3/087; C03C 3/091; B32B 2307/536; B32B 2307/54; B32B 2307/558; B32B 2605/08

(57) ABSTRACT

A glass plate including a first surface and a second surface facing the first surface, in which, when Vickers indentation is performed with a force of 5 N on the first surface or the second surface, no cracks are generated or c/l<0.50, and when a fracture toughness value is defined as K_{IC}, a crack length is defined as a, a Young's modulus is defined as E, an average thermal expansion coefficient at 20° ° C. to 300° C. is defined as α, and a temperature difference between a temperature T_{S1} on a first surface side and a temperature T_{S2} on a second surface side is defined as ΔT, the expression (1) is satisfied under conditions of 500× 10⁻⁶≤a≤2000×10⁻⁶ and 20≤ΔT≤45

$$\frac{{K}_{I C}}{\sqrt{π a}} > E αΔ T \qquad ( 1 )$$

### CROSS-REFERENCE TO RELATED APPLICATIONS

This is a bypass continuation of International Patent Application No. PCT/JP2022/039575, filed on Oct. 24, 2022, which claims priority to Japanese Patent Application No. 2021-175914, filed on Oct. 27, 2021. The contents of these applications are hereby incorporated by reference in their entireties.

### TECHNICAL FIELD

The present invention relates to a glass plate, a window glass for a vehicle, and a laminated glass, and particularly to a glass plate having high strength and high resistance to cracks when a surface temperature difference occurs on both surfaces of the glass plate, and a window glass for a vehicle and a laminated glass including the glass plate.

### BACKGROUND ART

Glass plates used for vehicular windshields and the like are required to have strength against external impacts caused by flying stones and the like during driving, that is, chipping resistance.

For example, Patent Literature 1 discloses a resin composition for an interlayer of a laminated glass, which can provide a laminated glass having high chipping resistance.

In addition, Patent Literatures 2 and 3 disclose a glass resin composite that can effectively attenuate impact energy of flying fragments.

### CITATION LIST

### Patent Literature

Patent Literature 1: JP2020-040869A
Patent Literature 2: JP2018-145082A
Patent Literature 3: JP2018-177601A

### SUMMARY OF INVENTION

Even with a glass plate having high resistance to cracks based on chipping resistance, when a temperature difference occurs between two spaces separated by the glass plate, such as outdoors and indoors, a stress differs on both surfaces of the glass plate, which tends to particularly decrease the resistance to cracks.

Therefore, the present invention provides a glass plate having high strength suitable for a window glass for a vehicle such as a windshield, and having high resistance to cracks when a surface temperature difference occurs on both surfaces of the glass plate, and a window glass for a vehicle and a laminated glass including the glass plate.

A glass plate according to an embodiment of the present invention includes:
a first surface; and
a second surface facing the first surface, in which
when Vickers indentation is performed with a force of 5 [N] on the first surface or the second surface, no cracks are generated or c/l<0.50 where c [mm] is an average length of a generated crack in a plan view of the first surface or the second surface and 1 [mm] is an average length that is half of a diagonal of an indentation, and
when a fracture toughness value is defined as K_{IC} [MPa·m^{1/2}], a crack length is defined as a [m], a Young's modulus is defined as E [MPa], an average thermal expansion coefficient at 20° ° C. to 300° C. is defined as α [K⁻¹], and a temperature difference between a temperature T_{S1} on a first surface side and a temperature T_{S2} on a second surface side is defined as ΔT [° C.], the following expression (1) is satisfied under conditions of 500×10⁻⁶ [m]≤a≤2000×10⁻⁶ [m] and 20≤ΔT≤45.

$$\frac{{K}_{IC}}{\sqrt{π a}} > E α Δ T \qquad ( 1 )$$

A glass plate according to an aspect of the present invention may have a composition represented by, in mol % in terms of oxide,

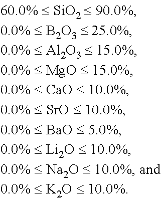

The glass plate according to the aspect of the present invention may have a composition represented by, in mol % in terms of oxide, 1.0%≤B₂O₃≤20.0%.

In the glass plate according to the aspect of the present invention, a total amount of SiO₂, B₂O₃ and Al₂O₃ may be 80.0% or more in mol % in terms of oxide.

The glass plate according to the aspect of the present invention may have a composition represented by, in mol % in terms of oxide,

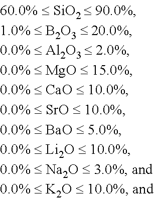

a total amount of SiO₂, B₂O₃ and Al₂O₃ may be 80.0% or more in mol % in terms of oxide.

The glass plate according to the aspect of the present invention may have a composition represented by, in mol % in terms of oxide,

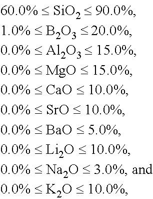

a total amount of SiO₂, B₂O₃ and Al₂O₃ may be 80.0% or more in mol % in terms of oxide, and
a total amount of Li₂O, Na₂O, K₂O, MgO, CaO, SrO and BaO may be 1.0% or more and 7.5% or less in mol % in terms of oxide.

In the glass plate according to the aspect of the present invention, a content of iron may be 500 ppm by mass or less.

In the glass plate according to the aspect of the present invention, the average thermal expansion coefficient at 20° ° C. to 300° ° C. may be 5.0×10⁻⁶ [K⁻¹] or less.

In the glass plate according to the aspect of the present invention, an infrared reflection film may be provided on or above the glass plate.

In the glass plate according to the aspect of the present invention, a thickness may be 2.0 mm or more.

In the glass plate according to the aspect of the present invention, the thickness may be 3.0 mm or more.

The glass plate according to the aspect of the present invention may be used for a window glass for a vehicle.

A laminated glass according to an embodiment of the present invention may include:
a first glass plate;
a second glass plate; and
an interlayer provided between the first glass plate and the second glass plate, in which
the first glass plate may be disposed on a vehicle-exterior side when the laminated glass is attached to a vehicle, and
the first glass plate may be the above glass plate.

In a laminated glass according to one aspect of the present invention, as the second glass plate, the above glass plate may be used.

The laminated glass according to the aspect of the present invention may be used for a windshield.

According to the present invention, it is possible to provide a glass plate having high strength and high resistance to cracks when a surface temperature difference occurs on both surfaces of the glass plate, and a laminated glass including the glass plate.

### BRIEF DESCRIPTION OF DRAWINGS

FIG. 1 is a schematic diagram of indentations and cracks for illustrating an average length c of cracks generated when Vickers indentation is performed.

FIG. 2 is a schematic diagram of indentations and cracks for illustrating an average length l that is half of diagonals of an indentation generated when Vickers indentation is performed.

FIG. 3 is a cross-sectional view of an example of a laminated glass according to the present embodiment.

FIG. 4 is a conceptual diagram illustrating a state in which the laminated glass according to the present embodiment is used as a window glass for a vehicle.

FIG. 5 is an enlarged view of a portion S in FIG. 4.

FIG. 6 is a cross-sectional view taken along a line Y-Y in FIG. 5.

### DESCRIPTION OF EMBODIMENTS

Hereinafter, embodiments of the present invention will be described in detail. In the following drawings, members and portions having the same functions may be denoted by the same reference numerals, and duplicate descriptions may be omitted or simplified. The embodiments described in the drawings are schematically for the purpose of clearly illustrating the present invention, and do not necessarily accurately represent a size or a scale of an actual product.

In the present description, unless otherwise specified, the expression that a glass “is substantially free of” a certain component means that the component is not contained except for inevitable impurities, and means that the component is not positively added. Specifically, it means that the content of each of these components in the glass is about 200 ppm or less in ppm by mol in terms of oxide.

### [Glass Plate]

A glass plate according to an embodiment of the present invention includes:
a first surface; and
a second surface facing the first surface, in which
when Vickers indentation is performed with a force of 5 [N] on the first surface or the second surface, no cracks are generated or c/l<0.50 where c [mm] is an average length of a generated crack in a plan view of the first surface or the second surface and 1 [mm] is an average length that is half of a diagonal of an indentation, and
when a fracture toughness value is defined as K_{IC} [MPa·m^{1/2}], a crack length is defined as a [m], a Young's modulus is defined as E [MPa], an average thermal expansion coefficient at 20° ° C. to 300° C. is defined as α [K⁻¹], and a temperature difference between a temperature T_{S1} on a first surface side and a temperature T_{S2} on a second surface side is defined as ΔT [° C.], the following expression (1) is satisfied under conditions of 500×10⁻⁶ [m]≤a≤2000×10⁻⁶ [m] and 20≤ΔT≤45.

$$\frac{{K}_{IC}}{\sqrt{π a}} > E α Δ T \qquad ( 1 )$$

The above Vickers indentation is a test for evaluating the resistance to flaws on the surface of the glass plate, that is, the chipping resistance, and specifically, refers to a test in which a square pyramidal indenter made of diamond having a facing angle of 136 degrees is pressed into a test piece under a constant load and the size of a dent generated after the load is removed is measured. When no cracks are generated around the dent generated by the above test or the above c/l is less than 0.50 in the glass plate according to the present embodiment, it is possible to obtain a glass that has a surface of the glass plate less likely to be damaged, that has excellent chipping resistance, and that is less likely to crack even when a thermal stress is generated due to a temperature difference.

In the above test, the “crack” means a crack generated in a direction away from the center of the indentation starting from the corner of the indentation, as a result of the above test, and the expression “no cracks are generated” means that no indentations are generated in the above test, or even when an indentation is generated, no cracks are generated in the direction away from the center of the indentation starting from the corner of the indentation. According to this test, it is possible to evaluate the ease with which cracks are generated in the glass and the ease with which cracks develop in the glass during mechanical contact with the glass.

The average length c [mm] of the generated crack in a plan view of the first surface or the second surface means a value obtained by dividing a total length from corners of the indentation to a tip of the respective crack by a total number of cracks.

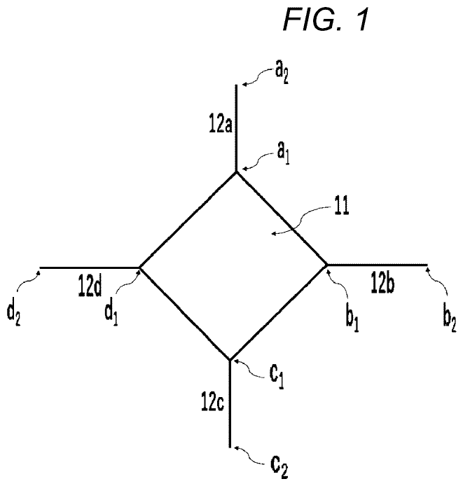

For example, in an indentation 11 shown in FIG. 1, one crack is generated at each of four corners (crack 12a to crack 12d). In this case, a length of the crack 12a corresponds to a length a₁₂ [mm] of a straight line connecting a corner a₁ of the indentation and a tip a₂ of the crack 12a. Similarly, a length of the crack 12b corresponds to a length b₁₂ [mm] of a straight line connecting a corner b₁ of the indentation and a tip b₂ of the crack 12b, a length of the crack 12c corresponds to a length c₁₂ [mm] of a straight line connecting a corner c₁ of the indentation and a tip c₂ of the crack 12c, and a length of the crack 12d corresponds to a length d₁₂ [mm] of a straight line connecting a corner d₁ of the indentation and a tip d₂ of the crack 12d. In this case, the total length of each of the cracks from each of the corners of the indentation is (a₁₂+b₁₂+c₁₂+d₁₂) [mm]. Since the total number of the cracks is 4, the average length c is expressed by the following equation:

$$c [ mm ] = ( {a}_{12} + {b}_{12} + {c}_{12} + {d}_{12} ) [ mm ] / 4.$$

Note that, as described above, the shape of the Vickers indenter is a square pyramid, so that the shape of the indentation is a square. Note that, cracks are not necessarily generated from all four corners of the indentation 11 as shown in FIG. 1. For example, in the case where no crack are generated from the corner d₁ among the corners a₁ to corner d₁, c [mm]=(a₁₂+b₁₂+c₁₂) [mm]/3.

The above c is preferably 0.022 mm or less, more preferably 0.020 mm or less, and still more preferably 0.018 mm or less.

The average length 1 [mm] of the diagonal of the indentation means a value obtained by dividing a total length of diagonals in the indentation generated in the above test by a total number of diagonals.

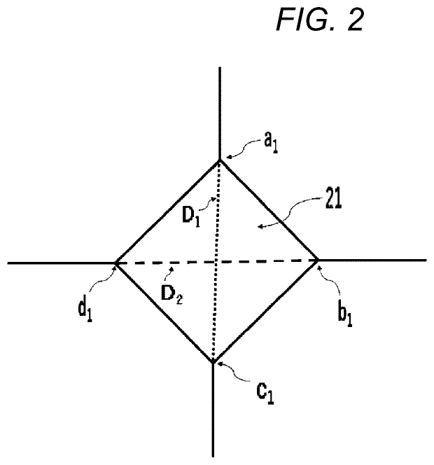

For example, in an indentation 21 shown in FIG. 2, there is a diagonal D₁ connecting the corner a₁ and the corner c₁ of the indentation, and a diagonal D₂ connecting the corner b₁ and the corner d₁ of the indentation. In this case, a length of the diagonal D₁ is a length a₁c₁ [mm] of a straight line connecting the corner a₁ and the corner c₁, and a length of the diagonal D₂ is a length b₁d₁ [mm] of a straight line connecting the corner b₁ and the corner d₁. Therefore, the total length of the diagonals in the indentation is (a₁c₁+b₁d₁) [mm]. Since the total number of the cracks is 2, the average length l is expressed by the following equation:

$$1 [ mm ] = ( {a}_{1} {c}_{1} + {b}_{1} {d}_{1} ) [ mm ] / 2.$$

Note that, as described above, the shape of the indentation is a square shape, so that the number of the diagonals is two.

In the glass plate according to the present embodiment, it is preferable that no cracks be generated in the above test. In the case where cracks are generated, c/l is less than 0.50. The fact that c/l is less than 0.50 means that the generated crack length is smaller than the length of the diagonal of the indentation by a certain amount, that is, means that the crack generated when an object collides with the glass is less likely to expand. The value of c/l is preferably less than 0.48, more preferably less than 0.46, and still more preferably less than 0.45.

In addition, the glass plate according to the present embodiment satisfy the above expression (1).

The above expression (1) means that in the case where a crack is generated on the surface of the glass plate, expansion of the crack due to the temperature difference between both surfaces of the glass plate is less likely to occur. Therefore, the glass plate according to the present embodiment that satisfies the above expression (1) has high resistance to cracks due to the temperature difference.

In the above expression (1), the fracture toughness value (K_{IC}) means a value determined by the method described in Examples to be described later.

In addition, the “crack” in the crack length (a) [m] means a crack that extends in an in-plane direction around a plastically deformed zone caused by collision with a flying object or an object being pushed into the surface of the glass, such as a scratch, and is similar to the crack that can be observed in the above indentation test. The “crack length (a)” has a correlation with the average length c of the crack obtained in the above indentation test.

In the above expression (1), the condition for the crack length (a) is 500×10⁻⁶ [m]≤a≤2000×10⁻⁶ [m]. When the crack length (a) is more than 2000×10⁻⁶ [m], there is a high possibility that the glass plate cracks (instantly) mainly due to the crack, regardless of the above ΔT condition. The present invention does not solve the problem of such an immediate fracture, but solves the problem of the generated crack expanding due to a stress caused by a temperature difference, leading to a fracture. In actual use environments, cracks are generated due to collision with flying stones and the like. At this time, in the case where the generated crack length (a) is 500×10⁻⁶ [m]≤a≤2000×10⁻⁶ [m], there is a possibility that the glass is not fractured immediately, but the crack expansion due to a thermal stress causes a fracture.

On the other hand, in the case where the generated crack is less than 500×10⁻⁶ [m], since the crack does not expand even under the above ΔT condition, the presence of the crack does not directly lead to a fracture. When the crack length (a) in the glass plate according to the present embodiment is 2000×10⁻⁶ [m] or less, even when ΔT is under the above condition, the glass plate does not crack (instantly) and the crack does not expand. In other words, it is important to evaluate the presence or absence of the resistance to cracks due to the temperature difference when the crack in the above range is present.

The condition for the crack length (a) may be 550×10⁻⁶ [m]≤a≤1800×10⁻⁶[m], or 600×10⁻⁶ [m]≤a≤1400×10⁻⁶ [m].

The average thermal expansion coefficient (α) at 20° C. to 300° C. is measured using a differential thermal dilatometer (TMA) and determined based on the standard in JIS R3102 (1995).

In the above expression (1), ΔT means |T_{S1}−T_{S2}|. In the above expression (1), the condition for ΔT is 20≤ΔT≤45. Here, the temperature T_{S1} on the first surface side means the temperature in a space on the first surface side, and the temperature T_{S2} on the second surface side means the temperature in a space on the second surface side. For example, in the case where the glass plate according to the present embodiment is used as a window glass for a vehicle, the temperature T_{S1} on the first surface side means the temperature outside a vehicle interior, and the temperature T_{S2} on the second surface side means the temperature inside the vehicle interior. The temperature T_{S1} and the temperature T_{S2} can be measured with a thermometer. In the above expression (1), the condition for ΔT may be 20≤ΔT≤43, 20≤ΔT ≤40, 30≤ΔT≤45, or ΔT=35.

Next, a composition range of each component contained in the glass plate according to the present embodiment will be described. Note that, the composition range of each component will hereinafter be expressed in a molar percentage in terms of oxide unless otherwise specified.

SiO₂ is an essential component in the glass plate according to the present embodiment. A content of SiO₂ is preferably 60.0% or more and 90.0% or less. SiO₂ contributes to improving the stability, the chemical durability, and the Young's modulus of the glass, thereby making it easier to ensure strength required for vehicle applications, and the like. When the content of SiO₂ is small, it is difficult to ensure weather resistance, and the average thermal expansion coefficient to be described later is too large, which may cause thermal cracks of the glass plate. On the other hand, when the content of SiO₂ is too large, the viscosity at the time of melting the glass increases, which may make it difficult to produce the glass.

The content of SiO₂ in the glass plate according to the present embodiment is more preferably 61.0% or more, still more preferably 62.0% or more, and particularly preferably 64.0% or more. The content of SiO₂ may be 80.0% or more, or may be 82.0% or more. In addition, the content of SiO₂ in the glass plate according to the present embodiment is more preferably 90.0% or less, still more preferably 87.0% or less, and particularly preferably 85.0% or less.

B₂O₃ is an optional component in the glass plate according to the present embodiment. A content of B₂O₃ is preferably 0.0% or more and 25.0% or less. B₂O₃ improves the glass strength and the resistance to cracks due to the temperature, and contributes to improving the meltability. It also contributes to improving millimeter radio wave transmissibility. By improving the millimeter radio wave transmissibility, the glass plate can be suitably used for a glass for automobiles and the like equipped with millimeter wave radars. Here, the “millimeter radio wave transmissibility” means an evaluation for radio wave (including quasi-millimeter wave and millimeter wave) transmissibility, and means, for example, radio wave transmissibility of a glass with respect to a radio wave having a frequency of 10 GHz to 90 GHz.

The content of B₂O₃ in the glass plate according to the present embodiment is more preferably 1.0% or more, still more preferably 3.0% or more, and particularly preferably 5.0% or more. The content of B₂O₃ may be 8.0% or more, or may be 10.0% or more.

In addition, when the content of B₂O₃ is too large, an alkali element is likely to volatilize during melting and forming, which may lead to a decrease in glass quality and a decrease in acid resistance and alkali resistance. Therefore, the content of B₂O₃ is more preferably 20.0% or less, still more preferably 19.5% or less, even more preferably 19.0% or less, and particularly preferably 18.5% or less. The content of B₂O₃ may be 15.0% or less, or may be 13.0% or less.

Al₂O₃ is an optional component in the glass plate according to the present embodiment. A content of Al₂O₃ is preferably 0.0% or more and 15.0% or less. Containing Al₂O₃ not only ensures the weather resistance but also improves the mechanical properties of the glass. In addition, thermal cracks of the glass plate due to an increase in average thermal expansion coefficient can be prevented. On the other hand, when the content of Al₂O₃ is too large, the viscosity at the time of melting the glass increases, which may make it difficult to bend the glass.

In the case where Al₂O₃ is contained, the content of Al₂O₃ is more preferably 0.25% or more, still more preferably 0.5% or more, and particularly preferably 1.0% or more in order to prevent phase separation of the glass and improve the weather resistance. The content of Al₂O₃ is more preferably 14.0% or less, still more preferably 13.5% or less, and particularly preferably 13.0% or less, from the viewpoint of keeping T₁₂, which is a bending and forming temperature of the glass, low to make the glass easier to produce, and from the viewpoint of increasing a millimeter radio wave transmittance. The content of Al₂O₃ may be 5.0% or less, 3.0% or less, 2.0% or less, less than 2.0%, less than 2%, or 1.5% or less. Here, T₁₂ means the temperature at which the glass viscosity is 10¹² dPa·s.

In the glass plate according to the present embodiment, SiO₂+B₂O₃+Al₂O₃, that is, a total amount of SiO₂, B₂O₃, and Al₂O₃, is preferably 80.0% or more. When the total amount of SiO₂, B₂O₃, and Al₂O₃ is 80.0% or more, the glass strength and the resistance to cracks due to the temperature are improved, and a decrease in weather resistance can be prevented. In addition, an increase in relative dielectric constant (εᵣ) and dielectric loss tangent (tan δ) can be prevented. The total amount of SiO₂, B₂O₃, and Al₂O₃ is more preferably 82.0% or more, and still more preferably 84.0% or more.

In addition, the total amount of SiO₂, B₂O₃, and Al₂O₃ is more preferably 97.0% or less, more preferably 96.5% or less, still more preferably 96.0% or less, and particularly preferably 80.0% or less, in consideration of keeping temperatures T₂ and T₄ of the glass plate according to the present embodiment low to make it easier to manufacture the glass. Here, T₂ means the temperature at which the glass viscosity is 102 dPa's, and T₄ means the temperature at which the glass viscosity is 10⁴ dPa·s.

MgO is an optional component in the glass plate according to the present embodiment. When the glass plate according to the present embodiment contains MgO in a predetermined amount, the glass viscosity decreases, and therefore, T₂ can be lowered, which contributes to improving the meltability of the glass. In addition, MgO is preferred because it can prevent an increase in relative dielectric constant as compared with CaO. On the other hand, when a content of MgO is too large, there is a risk of raising T₁₂, which is the bending and forming temperature of the glass.

The content of MgO is preferably 0.0% or more and 15.0% or less. MgO is a component that promotes melting of a glass raw material as described above and that improves the weather resistance and the Young's modulus. In the case where MgO is contained, the content thereof is more preferably 0.1% or more, still more preferably 1.0% or more, and particularly preferably 2.0% or more. In addition, when the content of MgO is 15.0% or less, it is possible to prevent an increase in relative dielectric constant (Cr) and dielectric loss tangent (tan δ) while controlling T₂ and T₁₂ in appropriate ranges. The content of MgO is preferably 15.0% or less, more preferably 13.0% or less, still more preferably 11.0% or less, particularly preferably 9.0% or less, and most preferably 7.5% or less.

CaO is an optional component in the glass plate according to the present embodiment, and may be contained in a certain amount for improving the meltability of the glass raw material. The content of CaO is preferably 0.0% or more and 10.0% or less. In the case where CaO is contained, the content thereof is more preferably 0.1% or more, still more preferably 1.0% or more, even more preferably 2.0% or more, particularly preferably 3.0% or more, and most preferably 4.0% or more. Accordingly, the melting property and the formability (decrease in T₂ and decrease in T₁₂) of the glass raw material are improved.

In addition, when the content of CaO is set to 10.0% or less, an increase in density of the glass is prevented, and low brittleness and the strength are maintained. In order to prevent degradation of brittleness of the glass and to prevent an increase in relative dielectric constant (εr) and dielectric loss tangent (tan δ) of the glass, the content of CaO is more preferably 9.0% or less, still more preferably 8.0% or less, even more preferably 7.0% or less, particularly preferably 6.0% or less, and most preferably 5.0% or less.

SrO is an optional component in the glass plate according to the present embodiment, and may be contained in a certain amount for improving the meltability of the glass raw material. The content of SrO is preferably 0.0% or more and 10.0% or less. In the case where SrO is contained, the content thereof is more preferably 0.10% or more, still more preferably 0.20% or more, even more preferably 0.30% or more, particularly preferably 0.40% or more, and most preferably 0.50% or more. Accordingly, the melting property and the formability (decrease in T₂ and decrease in T₁₂) of the glass raw material are improved.

In addition, when the content of SrO is set to 10.0% or less, an increase in density of the glass is prevented, and low brittleness and the strength are maintained. In order to prevent degradation of brittleness of the glass and to prevent an increase in relative dielectric constant (εᵣ) and dielectric loss tangent (tan δ) of the glass, the content of SrO is more preferably 9.0% or less. In addition, the content of SrO is more preferably 8.0% or less, still more preferably 7.0% or less, particularly preferably 6.0% or less, and most preferably 5.0% or less.

BaO is an optional component in the glass plate according to the present embodiment, and may be contained in a certain amount for improving the meltability of the glass raw material. The content of BaO is preferably 0.0% or more and 5.0% or less. In the case where BaO is contained, the content thereof is more preferably 0.1% or more, still more preferably 0.2% or more, and particularly preferably 0.3% or more. Accordingly, the melting property and the formability (decrease in T₂ and decrease in T₁₂) of the glass raw material are improved.

In addition, when the content of BaO is set to 5.0% or less, an increase in density of the glass is prevented, and low brittleness and the strength are maintained. In order to prevent degradation of brittleness of the glass and to prevent an increase in relative dielectric constant (εᵣ) and dielectric loss tangent (tan δ) of the glass, the content of BaO is more preferably 4.0% or less. In addition, the content of BaO is more preferably 3.0% or less, still more preferably 2.0% or less, and particularly preferably 1.0% or less, and it is most preferable that the glass plate be substantially free of BaO.

Li₂O is an optional component in the glass plate according to the present embodiment. When the glass plate according to the present embodiment contains Li₂O in a predetermined amount, the glass viscosity decreases, and therefore, T₂ can be lowered, which contributes to improving the meltability of the glass.

A content of Li₂O is preferably 0.0% or more and 10.0% or less. Li₂O is a component that improves the meltability of the glass as described above, and is a component that increases the Young's modulus and also contributes to improving the glass strength. Therefore, by containing Li₂O, the formability of glass plate is improved.

The content of Li₂O is more preferably 0.1% or more, still more preferably 0.2% or more, even more preferably 0.3% or more, particularly preferably 0.5% or more, and most preferably 1.0% or more.

On the other hand, when the content of Li₂O is too large, devitrification or the phase separation may occur at the time of producing the glass, which may make the production difficult. In addition, a large content of Li₂O may cause an increase in raw material cost and an increase in relative dielectric constant (εᵣ) and dielectric loss tangent (tan δ). Therefore, the content of Li₂O is more preferably 9.0% or less, still more preferably 8.0% or less, even more preferably 7.0% or less, particularly preferably 6.0% or less, and most preferably 5.0% or less.

Na₂O is an optional component in the glass plate according to the present embodiment. The content of Na₂O is preferably 0.0% or more and 10.0% or less. When Na₂O is contained, the glass viscosity decreases, and thus the formability of the glass plate is improved. In the case where Na₂O is contained, the content thereof is more preferably 0.10% or more, still more preferably 0.20% or more, even more preferably 0.30% or more, particularly preferably 0.40% or more, and most preferably 0.50% or more.

On the other hand, when the content of Na₂O is too large, the glass strength and the resistance to cracks due to the temperature decease. In addition, it causes an increase in relative dielectric constant (εᵣ) and dielectric loss tangent (tan δ). Therefore, the content of Na₂O is more preferably 9.0% or less, still more preferably 7.0% or less, even more preferably 5.0% or less, particularly preferably 4.0% or less, and most preferably 3.0% or less.

K₂O is an optional component in the glass plate according to the present embodiment. A content of K₂O is preferably 0.0% or more and 10.0% or less. When K₂O is contained, the glass viscosity decreases, and thus the formability of the glass plate is improved. In the case where K₂O is contained, the content thereof is more preferably 0.10% or more, still more preferably 0.20% or more, even more preferably 0.30% or more, particularly preferably 0.40% or more, and most preferably 0.50% or more.

On the other hand, an excessively large content of K₂O causes an increase in relative dielectric constant (εᵣ) and dielectric loss tangent (tan δ). Therefore, the content of K₂O is more preferably 9.0% or less, still more preferably 7.0% or less, even more preferably 5.0% or less, particularly preferably 4.0% or less, and most preferably 3.0% or less.

In the glass plate according to the present embodiment, a content of R₂O is preferably 0.0% or more and 10.0% or less. Here, R₂O means a total content of Li₂O, Na₂O, and K₂O. When the content of R₂O in the glass plate according to the present embodiment is 10.0% or less, the glass strength and the resistance to cracks due to the temperature can be prevented from deceasing. In addition, the formability of the glass plate is improved while maintaining the weather resistance and the millimeter radio wave transmissibility. R₂O in the glass plate according to the present embodiment is more preferably 9.0% or less, still more preferably 8.0% or less, particularly preferably 7.0% or less, and most preferably 6.0% or less.

In addition, from the viewpoint of lowering the temperatures T₂ and T₁₂ during the production, or in order to facilitate heating by directly applying electricity to a glass melt, R₂O in the glass plate according to the present embodiment is more preferably 0.1% or more, still more preferably 0.5% or more, particularly preferably 1.0% or more, and most preferably 2.0% or more.

The glass plate according to the present embodiment preferably contains 500 ppm by mass or less of iron, and is more preferably substantially free of iron. When the content of iron is within the above range, since a transmittance of visible light and near-infrared light is high, the glass plate is suitable for LiDAR (light detection and ranging) applications. In addition, in HUD (Head-Up Display) applications, the occurrence of color unevenness in the glass can be prevented. Further, homogeneity of the glass is increased, and the occurrence of unevenness in a refractive index can be prevented. In addition, the glass plate according to the present embodiment preferably contains 250 ppm by mol or less of iron.

Here, the expression “being substantially free of iron” means that the content in the glass is about 200 ppm or less in ppm by mass in terms of oxide. In addition, the expression “being substantially free of iron” means that the content in the glass is about 100 ppm or less in ppm by mol in terms of oxide.

RO represents a total content of MgO, CaO, SrO, and BaO. The content of RO is preferably 0.0% or more and 20.0% or less. When the content of RO in the glass plate according to the present embodiment is 20.0% or less, an increase in relative dielectric constant (Cr) and dielectric loss tangent (tan δ) can be prevented while maintaining the weather resistance. The content of RO in the glass plate according to the present embodiment is more preferably 19.0% or less, still more preferably 18.0% or less, even still more preferably 17.0% or less, particularly preferably 16.0% or less, and most preferably 15.5% or less.

In addition, RO may be contained from the viewpoint of lowering the temperatures T₂ and T₁₂ during the production, and from the viewpoint of improving the formability of the glass plate, the content of RO in the glass plate according to the present embodiment is more preferably 1.0% or more, still more preferably 2.0% or more, particularly preferably 3.0% or more, and most preferably 4.0% or more.

In the glass plate according to the present embodiment, a total content of R₂O and RO (R₂O+RO) is preferably 1.0% or more and 7.5% or less. Here, R₂O+RO means the total content of Li₂O, Na₂O, K₂O, MgO, CaO, SrO and BaO. When R₂O+RO in the glass plate according to the present embodiment is 7.5% or less, it is possible to provide a glass having excellent chipping resistance while having a lowered melting temperature. R₂O+RO in the glass plate according to the present embodiment is more preferably 7.4% or less, still more preferably 7.3% or less, particularly preferably 7.2% or less, and most preferably 7.0% or less. In addition, when R₂O+RO in the glass plate according to the present embodiment is 1.0% or more, it is possible to provide a glass having excellent chipping resistance. R20+RO in the glass plate according to the present embodiment is more preferably 1.5% or more, still more preferably 2.0% or more, particularly preferably 3.0% or more, and most preferably 3.5% or more.

In the glass plate according to the present embodiment, T₁₂ is preferably 750° C. or lower. When T₁₂ is 750° C. or lower, it is possible to perform bending forming at a low temperature. Examples of a method for setting T₁₂ to 750° C. or lower include a method of adjusting the contents of CaO, MgO, Li₂O, and the like to a predetermined range. In the glass plate according to the present embodiment, T₁₂ is more preferably 700° C. or lower, still more preferably 680° C.′ or lower, even more preferably 670° C. or lower, even still more preferably 660° C. or lower, and yet still more preferably 650° C. or lower. In addition, from the viewpoint of a firing temperature of a black ceramic, which is an example of a light shielding layer to be printed on a windshield, T₁₂ is preferably 500° C. or higher, more preferably 520° ° C. or higher, still more preferably 540° C. or higher, and particularly preferably 560° C. or higher.

The glass plate according to the present embodiment preferably has a low dielectric loss tangent (tan δ) by adjusting the composition. When the glass plate according to the present embodiment has a low dielectric loss tangent, a dielectric loss can be reduced and a high millimeter radio wave transmittance can be achieved. In addition, the glass plate according to the present embodiment preferably has a low relative dielectric constant (εᵣ) by adjusting the composition, similar to the above. When the glass plate according to the present embodiment has a low relative dielectric constant, reflection of radio waves at an interface with the interlayer can be prevented and a high millimeter radio wave transmittance can be achieved.

The relative dielectric constant (εᵣ) of the glass plate according to the embodiment at a frequency of 10 GHz is preferably 6.5 or less. When the relative dielectric constant (εᵣ) at a frequency of 10 GHz is 6.5 or less, a difference in relative dielectric constant (εᵣ) from the interlayer is small, and the reflection of radio waves at the interface with the interlayer can be prevented. The relative dielectric constant (εᵣ) of the glass plate according to the present embodiment at a frequency of 10 GHz is more preferably 6.4 or less, still more preferably 6.3 or less, even more preferably 6.2 or less, particularly preferably 6.1 or less, and most preferably 6.0 or less. In addition, a lower limit of the relative dielectric constant (εᵣ) of the glass plate according to the present embodiment at a frequency of 10 GHz is not particularly limited, and is, for example, 4.5 or more.

The dielectric loss tangent (tan δ) of the glass plate according to the present embodiment at a frequency of 10 GHz is preferably 0.0090 or less. When the dielectric loss tangent (tan δ) at a frequency of 10 GHz is 0.0090 or less, a radio wave transmittance can be increased. The dielectric loss tangent (tan δ) of the glass plate according to the present embodiment at a frequency of 10 GHz is more preferably 0.0089 or less, still more preferably 0.0088 or less, even more preferably 0.0087 or less, particularly preferably 0.0086 or less, and most preferably 0.0085 or less. In addition, a lower limit of the dielectric loss tangent (tan δ) of the glass plate according to the present embodiment at a frequency of 10 GHz is not particularly limited, and is, for example, 0.0050 or more.

When the relative dielectric constant (εᵣ) and the dielectric loss tangent (tan δ) of the glass plate according to the present embodiment at a frequency of 10 GHz satisfy the above ranges, a high millimeter radio wave transmittance can be implemented even at a frequency of 10 GHz to 90 GHz.

The relative dielectric constant (εᵣ) and the dielectric loss tangent (tan δ) of the glass plate according to the present embodiment at a frequency of 10 GHz can be measured with, for example, a split post dielectric resonator method (SPDR method). For such a measurement, a nominal fundamental frequency of 10 GHz type split post dielectric resonator manufactured by QWED Company, a vector network analyzer E8361C manufactured by Keysight Technologies, 85071E option 300 dielectric constant calculation software manufactured by Keysight Technologies, or the like may be used.

The average thermal expansion coefficient at 20° C. to 300° C. of the glass plate according to the present embodiment is preferably 5.0×10⁻⁶ [K⁻¹] or less. In the case where the average thermal expansion coefficient is within the above range, when a temperature difference occurs between the first surface side and the second surface side of the glass plate according to the present embodiment, a difference in expansion between the first surface side and the second surface side of the glass plate is kept small, making it difficult for cracks to generate due to strain. Further, in a forming step and a slow cooling step of the glass plate, or a forming step of a window glass plate for a vehicle, it is possible to prevent generation of a thermal stress due to a temperature distribution of the glass plate, and to prevent generation of thermal cracks of the glass plate. The average thermal expansion coefficient at 20° ° C. to 300° C. of the glass plate according to the present embodiment is more preferably 4.8×10⁻⁶ [K⁻¹] or less, and still more preferably 4.6×10⁻⁶ [K⁻¹] or less.

On the other hand, the average thermal expansion coefficient at 20° C. to 300° C. of the glass plate according to the present embodiment is preferably 2.0×10⁻⁶ [K⁻¹] or more. When the average thermal expansion coefficient of the glass plate according to the present embodiment is 2.0×10⁻⁶ [K⁻¹] or more, the glass viscosity can be lowered, making it possible to form a glass plate. This is possible, for example, by containing an R₂O component or an RO component.

The average thermal expansion coefficient at 20° C. to 300° C. of the glass plate according to the present embodiment is more preferably 2.5×10⁻⁶ [K⁻¹] or more, and particularly preferably 2.8×10⁻⁶ [K⁻¹] or more.

As described above, the average thermal expansion coefficient at 20° C. to 300° C. of the glass plate according to the present embodiment is measured using a differential thermal dilatometer (TMA) and determined based on the standard in JIS R3102 (1995).

The glass plate according to the present embodiment may have a density of 2.2 g/cm³ or more and 2.6 g/cm³ or less. In addition, the glass plate according to the present embodiment may have a Young's modulus (E) of 60×10³ MPa or more and 90×10³ MPa or less. When the glass plate according to the present embodiment satisfies these conditions, the glass plate can be suitably used as a window glass plate for a vehicle, or the like.

The glass plate according to the present embodiment preferably contains a certain amount or more of SiO₂ in order to ensure the weather resistance, and as a result, the density of the glass plate according to the present embodiment may be 2.2 g/cm³ or more. The density of the glass plate according to the present embodiment is preferably 2.3 g/cm³ or more. When the density is 2.2 g/cm³ or more, a sound insulating property in a room and in the vehicle interior is improved. In addition, when the density of the glass plate according to the present embodiment is 2.6 g/cm³ or less, the glass plate is less likely to be brittle, and a high sound insulating property can be maintained. The density of the glass plate according to the present embodiment is preferably 2.5 g/cm³ or less.

The glass plate according to the present embodiment has a high rigidity as the Young's modulus increases, and becomes more suitable for the window glass for a vehicle or the like. The Young's modulus of the glass plate according to the present embodiment is preferably 55×10³ MPa or more, more preferably 57×10³ MPa or more, still more preferably 59×10³ MPa or more, and particularly preferably 60×10³ MPa or more.

On the other hand, when the content of Al₂O₃ or MgO is increased in order to increase the Young's modulus, the relative dielectric constant (εᵣ) and the dielectric loss tangent (tan δ) of the glass increase, and therefore, the millimeter radio wave transmittance may decrease. Therefore, in the glass plate according to the present embodiment, the content of Al₂O₃ or MgO may be adjusted, and an appropriate Young's modulus is 90×10³ MPa or less, more preferably 88×10³ MPa or less, and still more preferably 86×10³ MPa or less.

In addition, in the glass plate according to the present embodiment, T_{g} is preferably 450° C. or higher and 600° C. or lower. Note that, in the present description, T_{g} represents a glass transition point of the glass. When T_{g} is within this predetermined temperature range, the bending processing of the glass can be performed within a normal producing condition range. When T_{g} of the glass plate according to the present embodiment is lower than 450° C., there is no problem in the formability, but an alkali content or an alkaline earth content becomes too large, and problems that the millimeter radio wave transmittance is decreased, thermal expansion of the glass is excessive, the weather resistance is decreased, and the like are likely to occur. In addition, when T_{g} of the glass plate according to the present embodiment is lower than 450° C., the glass may devitrify and may not be formed in a forming temperature range.

T_{g} of the glass plate according to the present embodiment is more preferably 470° C. or higher, still more preferably 490° ° C. or higher, and particularly preferably 510° C. or higher. On the other hand, when T_{g} is too high, productivity decreases due to high-temperature control during glass bending processing, and therefore, T_{g} of the glass plate according to the present embodiment is more preferably 590° C. or less, still more preferably 580° C. or less, and particularly preferably 570° C. or less.

The glass plate according to the present embodiment has a fracture toughness value (K_{IC}) of preferably 0.55 MPa·m^{1/2} or more, more preferably 0.58 MPa·m^{1/2} or more, and still more preferably 0.60 MPa·m^{1/2} or more. When the fracture toughness value of the glass plate according to the present embodiment is within the above range, the resistance to cracks when a surface temperature difference occurs on both surfaces of the glass plate is high. The fracture toughness value (K_{IC}) is determined by the method detailed in Examples to be described later.

The glass plate according to the present embodiment may contain components other than the above-described SiO₂, B₂O₃, Al₂O₃, MgO, CaO, SrO, BaO, Li₂O, Na₂O, and K₂O (hereinafter, also referred to as “other components”), and in the case where other components are contained, a total amount thereof is preferably 5.0% or less. Examples of the other components include ZnO, P₂O₅, ZrO₂, Y₂O₃, Nd₂O₅, GaO₂, GeO₂, MnO₂, CoO, Cr₂O₃, V₂O₅, Se, Au₂O₃, Ag₂O, CuO, CdO, SO₃, Cl, F, SnO₂, Sb₂O₃, and NiO, and the other components may be metal ions or oxides. The other components may be contained in an amount of 5.0% or less for various purposes (for example, refining and coloring). When the total amount of the other components is more than 5.0%, the millimeter radio wave transmittance may be decreased.

The total amount of the other components is preferably 2.0% or less, more preferably 1.0% or less, still more preferably 0.50% or less, particularly preferably 0.30% or less, and most preferably 0.10% or less. In order to prevent an influence on the environment, each of a content of As₂O₃ and a content of PbO is preferably less than 0.0010%.

The glass plate according to the present embodiment may contain ZnO to decrease the glass viscosity. A content of ZnO is preferably 0.0% or more and 10.0% or less. In the case where ZnO is contained, the content thereof is preferably 0.1% or more, more preferably 0.5% or more, and still more preferably 1.0% or more.

In addition, when the content of ZnO is set to 10.0% or less, an increase in relative dielectric constant (εᵣ) and dielectric loss tangent (tan δ) can be prevented. In order to prevent an increase in relative dielectric constant (εᵣ) and dielectric loss tangent (tan δ), the content of ZnO is more preferably 7.0% or less, still more preferably 5.0% or less, and particularly preferably 3.0% or less.

The glass plate according to the present embodiment may contain P₂O₅. A content of P₂O₅ nay be 0.0% or more and 10.0% or less. P₂O₅ has a function of decreasing the glass viscosity. In the case where P₂O₅ is contained in the glass plate according to the present embodiment, the content thereof is preferably 0.2% or more, more preferably 0.5% or more, still more preferably 0.8% or more, and particularly preferably 1.0% or more.

On the other hand, P₂O₅ tends to cause defects in the glass in a float bath in the case where the glass plate according to the present embodiment is produced with a float method. Therefore, the content of P₂O₅ in the glass plate according to the present embodiment is preferably 5.0% or less, more preferably 4.0% or less, still more preferably 3.0% or less, and particularly preferably 2.0% or less.

The glass plate according to the present embodiment may contain Cr₂O₃. Cr₂O₃ can act as an oxidant to control an amount of FeO. In the case where the glass plate according to the present embodiment contains Cr₂O₃, a content thereof is preferably 0.0020% or more, and more preferably 0.0040% or more. Since Cr₂O₃ has coloring in light in a visible region, the visible light transmittance may be decreased. Therefore, in the case where the glass plate according to the present embodiment contains Cr₂O₃, the content thereof is preferably 1.0% or less, more preferably 0.50% or less, still more preferably 0.30% or less, and particularly preferably 0.10% or less.

The glass plate according to the present embodiment may contain SnO₂. SnO₂ can act as a reducing agent to control the amount of FeO. In the case where the glass plate according to the present embodiment contains SnO₂, a content thereof is preferably 0.010% or more, more preferably 0.040% or more, still more preferably 0.060% or more, and particularly preferably 0.080% or more. On the other hand, in order to prevent defects derived from SnO₂ during the production of the glass plate, the content of SnO₂ in the glass plate according to the present embodiment is preferably 1.0% or less, more preferably 0.50% or less, still more preferably 0.30% or less, and particularly preferably 0.20% or less.

The glass plate according to the present embodiment may contain NiO, but when NiO is contained, formation of NiS may cause glass breakage. Therefore, a content of NiO is preferably 0.010% or less, and more preferably 0.0050% or less, and it is still more preferable that the glass plate be substantially free of NiO. Here, the expression “being substantially free of NiO” means that the content of NiO in the glass is about 30 ppm or less in ppm by mol in terms of oxide.

The glass plate according to the present embodiment preferably has a sufficient visible light transmittance, and when a thickness of the glass plate is converted into 2.00 mm, a visible light transmittance Tv defined by ISO-9050:2003 using a D65 light source is preferably 75% or more, more preferably 77% or more, and still more preferably 80% or more. In addition, Tv is, for example, 90% or less.

The glass plate according to the present embodiment preferably has a high heat insulation property, and when the thickness is converted into 2.00 mm, a total solar transmittance Tts defined by ISO-13837:2008 convention A and measured at a wind speed of 4 m/s is preferably 88% or less, more preferably 80% or less, and still more preferably 78% or less. In addition, Tts is, for example, 70% or more.

The glass plate according to the present embodiment preferably has a low ultraviolet transmissibility, and when the thickness is converted into 2.00 mm, an ultraviolet transmittance Tuv defined by ISO-9845A (1992) is preferably 80% or less, more preferably 70% or less, still more preferably 60% or less, and particularly preferably 50% or less. In addition, Tuv is, for example, 10% or more.

In the glass plate according to the present embodiment, when the thickness is converted into 2.00 mm, a* defined by JIS Z 8781-4 (2013) using a D65 light source is preferably −5.0 or more, more preferably −3.0 or more, and still more preferably −2.0 or more. In addition, a* is preferably 2.0 or less, more preferably 1.0 or less, and still more preferably 0 or less.

Further, in the glass plate according to the present embodiment, when the thickness is converted into 2.00 mm, b* defined by JIS Z 8781-4 (2013) using a D65 light source is preferably −5.0 or more, more preferably −3.0 or more, and still more preferably −1.0 or more. In addition, b* is preferably 5.0 or less, more preferably 4.0 or less, and still more preferably 3.0 or less. When a* and b* are within the above ranges, the glass plate according to the present embodiment is excellent in design as a window glass for a vehicle.

From the viewpoint of the glass strength and the sound insulating property, the thickness of the glass plate according to the present embodiment is preferably 2.0 mm or more, more preferably 2.3 mm or more, still more preferably 2.5 mm or more, even more preferably 2.7 mm or more, and particularly preferably 3.0 mm or more.

In addition, from the viewpoint of a glass weight and bending properties, the thickness is preferably 5.0 mm or less, more preferably 4.0 mm or less, still more preferably 3.8 mm or less, and particularly preferably 3.6 mm or less.

A method for producing the glass plate according to the present embodiment is not particularly limited, and for example, a glass plate formed with a known float method is preferred. In the float method, a molten glass base material is floated on a molten metal such as tin, and a glass plate having a uniform thickness and width is formed under strict temperature control. Alternatively, a glass plate formed with a known roll-out method or down draw method may be used, or a glass plate having a polished surface and a uniform thickness may be used. Here, the down draw method is roughly classified into a slot down draw method and an overflow down draw method (fusion method), and both of the methods are methods in which a molten glass is continuously poured down from a formed body to form a glass ribbon in a band plate shape.

The glass plate according to the present embodiment may be subjected to thermal strengthening. A thermally strengthened glass is obtained by subjecting the glass plate to a heat strengthening treatment. In the heat strengthening treatment, a uniformly heated glass plate is rapidly cooled from a temperature near a softening point, and a compressive stress is generated on the surface of the glass plate due to a temperature difference between the surface of the glass plate and an inside of the glass. The compressive stress is generated uniformly over the entire surface of the glass, and a compressive stress layer having a uniform depth is formed over the entire surface of the glass. The heat strengthening treatment is more suitable for strengthening a thick glass plate than a chemical strengthening treatment.

Generally, a glass having a low alkali content or free of an alkali has a small average thermal expansion coefficient, and thus there is a problem that it is difficult to apply the thermal strengthening. However, the glass plate according to the present embodiment has an average thermal expansion coefficient larger than that of a glass plate having a low alkali content or a glass plate free of an alkali in the related art, and thus can be subjected to the thermal strengthening.

In the glass plate according to the present embodiment, an infrared reflection film may be provided on or above the glass plate. Examples of the infrared reflection film include known infrared reflection films such as a dielectric multilayer film, a liquid crystal alignment film, a coating film containing an infrared reflection material, and a single-layer or multilayer infrared reflection film having a metal film. A film thickness of the infrared reflection film is preferably 100 nm to 500 nm, and more preferably 150 nm to 450 nm. In addition, a total thickness of the infrared reflection film and a support film is preferably 25 μm to 200 μm, and more preferably 50 μm to 120 μm, as shown above as the thickness of the infrared reflection film.

The glass plate according to the present embodiment can be used as a window glass for a vehicle or the like, and is used, for example, as a windshield, a door glass to be mounted to a side door, a side glass, a rear glass, or the like.

[Laminated Glass]

A laminated glass according to an embodiment of the present invention includes: a first glass plate; a second glass plate; and an interlayer provided between the first glass plate and the second glass plate, in which the first glass plate is disposed on a vehicle-exterior side when attached to a vehicle, and the first glass plate is the above glass plate.

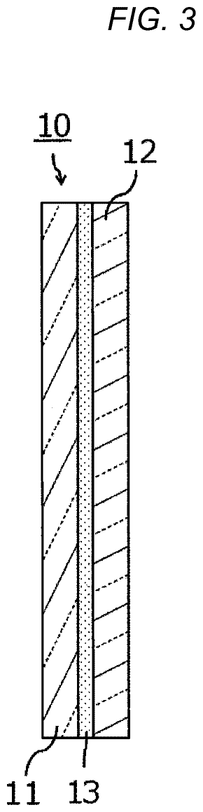

FIG. 3 is a view illustrating an example of a laminated glass 10 according to the present embodiment. The laminated glass 10 includes a first glass plate 11, a second glass plate 12, and an interlayer 13 provided between the first glass plate 11 and the second glass plate 12. Here, the first glass plate 11 is disposed on the vehicle-exterior side when attached to the vehicle, and the second glass plate 12 is disposed on a vehicle-interior side when attached to the vehicle.

Note that, the laminated glass 10 according to the present embodiment is not limited to an aspect in FIG. 3, and can be modified without departing from the gist of the present invention. For example, the interlayer 13 may be formed as one layer as illustrated in FIG. 3, or may be formed as two or more layers. In addition, the laminated glass 10 according to the present embodiment may include three or more glass plates, and in this case, an organic resin or the like may be interposed between adjacent glass plates. Hereinafter, the laminated glass 10 according to the present embodiment will be described as a configuration in which only two glass plates, that is, the first glass plate 11 and the second glass plate 12 are included, and the interlayer 13 is sandwiched therebetween.

In the laminated glass according to the present embodiment, the above glass plate is used for the first glass plate 11 disposed on the vehicle-exterior side when attached to the vehicle. From the viewpoint of the strength and the resistance to cracks based on a surface temperature difference, it is preferable to use the above glass plates for both the first glass plate 11 and the second glass plate 12. In this case, the first glass plate 11 and the second glass plate 12 may be glass plates having the same composition or glass plates having different compositions.

In the case where the second glass plate 12 is not the above glass plate, the type of the glass plate is not particularly limited, and a known glass plate in the related art used for a window glass for a vehicle or the like can be used. Specific examples thereof include an alkali aluminosilicate glass and a soda lime glass. These glass plates may be colored to such an extent that transparency thereof is not impaired, or may not be colored.

The interlayer 13 according to the present embodiment is provided between the first glass plate 11 and the second glass plate 12. Since the laminated glass 10 according to the present embodiment includes the interlayer 13, the first glass plate 11 and the second glass plate 12 firmly adhere to each other, and an impact force when scattered pieces collide with the glass plate can be reduced. A thickness of the second glass plate 12 is also set freely.

As the interlayer 13, various organic resins generally used for a laminated glass used as a vehicular laminated glass in the related art may be used. For example, an ethylene vinyl acetate copolymer (EVA) and polyvinyl butyral (PVB) are suitable, and PVB is particularly preferred because it can impart the sound insulating property. A thickness of the interlayer 13 is also set freely.

### [Other Layers]

The laminated glass 10 according to the present embodiment may include layers other than the first glass plate 11, the second glass plate 12, and the interlayer 13 (hereinafter, also referred to as “other layers”) within a range that does not impair effects of the present invention. For example, a coating layer that provides a water repellent function, a hydrophilic function, an anti-fogging function, or the like, or the above infrared reflection film may be provided.

Positions where the other layers are provided are not particularly limited, and the other layers may be provided on a surface of the laminated glass 10, or may be sandwiched between the first glass plate 11, the second glass plate 12, or the interlayer 13. In addition, the laminated glass 10 according to the present embodiment may include a black ceramic layer or the like which is disposed in a band shape on a part or all of a peripheral edge area for the purpose of hiding an attachment area to a frame body or the like, a wiring conductor, or the like.

A method for producing the laminated glass 10 according to the present embodiment may be the same as that for a known laminated glass in the related art. For example, through a step of laminating the first glass plate 11, the interlayer 13, and the second glass plate 12 in this order and performing heating and pressing, the laminated glass 10 having a configuration in which the first glass plate 11 and the second glass plate 12 are bonded via the interlayer 13 is obtained.

In the method for producing the laminated glass 10 according to the present embodiment, for example, after a step of heating and forming each of the first glass plate 11 and the second glass plate 12, a step of inserting the interlayer 13 between the first glass plate 11 and the second glass plate 12 and performing heating and pressing may be performed. Through such steps, the laminated glass 10 having the configuration in which the first glass plate 11 and the second glass plate 12 are bonded via the interlayer 13 may be obtained.

The laminated glass according to the present embodiment is used as a window glass for a vehicle or the like.

Hereinafter, an example in which the laminated glass 10 according to the present embodiment is used as a window glass for a vehicle, especially a windshield, will be described with reference to the drawings.

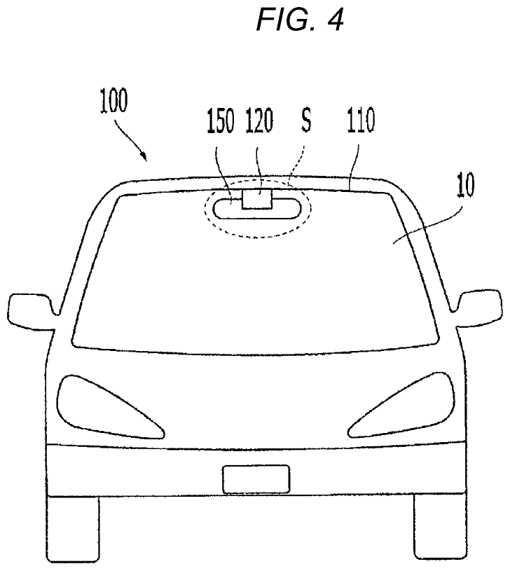

FIG. 4 is a conceptual diagram illustrating a state in which the laminated glass 10 according to the present embodiment is mounted on an opening 110 formed at a front part of a vehicle 100 and used as a window glass (windshield) of the vehicle. In the laminated glass 10 used as the window glass of the vehicle, a housing (case) 120 in which an information device or the like is housed for ensuring traveling safety of the vehicle may be attached to a surface on an inner side of the vehicle.

The information device housed in the housing is a device that uses a camera, a radar, or the like to prevent rear-end collision or collision with a preceding vehicle, a pedestrian, an obstacle, or the like in front of the vehicle or to notify a driver of a danger. For example, the information device is an information receiving device and/or an information transmitting device, includes a millimeter wave radar, a stereo camera, an infrared laser, or the like, and transmits and receives a signal. The “signal” is an electromagnetic wave including a millimeter wave, visible light, or infrared light.

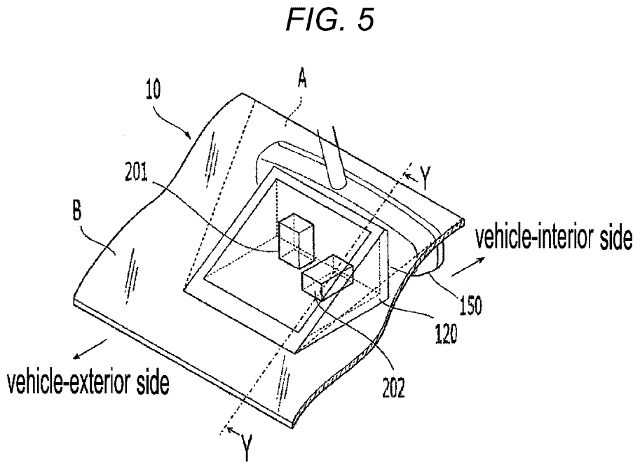

FIG. 5 is an enlarged view of a portion S in FIG. 4, and is a perspective view illustrating a portion where the housing 120 is attached to the laminated glass 10 according to the present embodiment. The housing 120 houses a millimeter wave radar 201 and a stereo camera 202 as the information device. The housing 120 in which the information device is housed is generally attached to a vehicle-exterior side with respect to a back mirror 150 and a vehicle-interior side with respect to the laminated glass 10, or may be attached to another portion.

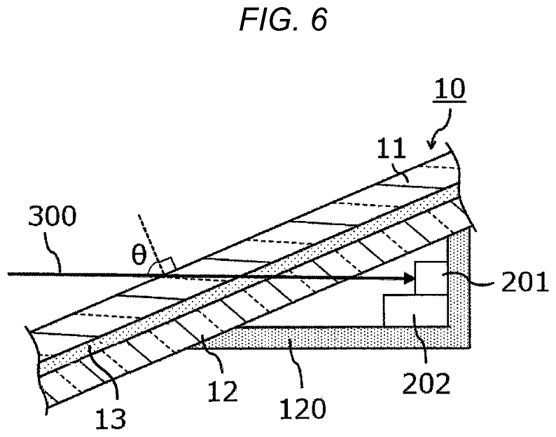

FIG. 6 is a cross-sectional view including a line Y-Y in FIG. 5 in a direction orthogonal to a horizontal line. The first glass plate 11 of the laminated glass 10 is disposed on the vehicle-exterior side. Note that, as described above, an incident angle θ of a radio wave 300 used for communication of the information device such as the millimeter wave radar 201 with respect to a main surface of the first glass plate 11 can be evaluated as, for example, 20°, 45°, or 60° as described above.

### EXAMPLES

Hereinafter, the present invention will be specifically described with reference to Examples, but the present invention is not limited thereto.

### <Preparation of Glass Plates in Example 1 to Example 8>

Raw materials were charged into a platinum crucible so as to obtain each glass composition (unit: mol %) shown in Table 1, and melted at 1,650° ° C. for 3 hours to obtain each molten glass. The molten glass was poured onto a carbon plate and slowly cooled. Both surfaces of the obtained plate-shaped glass were polished to obtain a glass plate having a thickness of 10 mm. Example 1 to Example 5 are Inventive Examples, and Example 6 to Example 8 are Comparative Examples.

### <Vickers Indentation Test>

The glass plates in Example 1 to Example 8 were subjected to a Vickers indentation test. The Vickers indentation test was carried out using a Micro Vickers hardness meter (FM810) manufactured by FUTURE-TECH CORP. As the conditions for press-fitting the indenter, a load of 5 [N] was applied, the pressing speed was 60 μm/sec, and the load was removed after holding for 15 seconds. The presence or absence of cracks generated 15 seconds after load removal, and in the case where cracks were generated, the average length c of the cracks and the average length l that was half of the diagonals of the indentation were measured, and c/l was calculated.

The crack length was measured using an optical microscope attached to the above apparatus. Note that, the “cracks” as used herein means cracks that are generated radially from a plastically deformed zone caused by press-fitting with a Vickers indenter.

### <Sufficiency Regarding Expression (1) for Glass Plate>

Assuming that, in the glass plates in Example 1 to Example 8, ΔT was 35° C. and there was a crack having a crack length a [m] of 500×10⁻⁶ [m]≤a≤2000×10⁻⁶ [m], the glass plates in Example 1 to Example 8 were examined to see whether the glass plates in Example 1 to Example 8 satisfy the above expression (1).

Methods for determining numerical values shown in Table 1 are shown below.

(1) Average Thermal Expansion Coefficient (a) at 20° C. to 300° ° C.:

The average thermal expansion coefficient was measured using a differential thermal dilatometer (TMA) and was determined based on the standard in JIS R3102 (1995). (2) Young's Modulus (E):

The Young's modulus was measured at 25° C. with an ultrasonic pulse method (Olympus, DL35).

(3) Fracture Toughness Value (K_{IC}):

The fracture toughness value was measured using an autograph (AGS-X manufactured by Shimadzu Corporation) by a DCDC method (double cleavage drilled compression method). (4) Sufficiency Regarding Expression (1):

The case where the above expression (1) was satisfied was evaluated as “A”, and the case where it was not satisfied was evaluated as “B”.

The measurement results are shown in Table 1.

TABLE 1

| mol % | | Example 1 | Example 2 | Example 3 | Example 4 | Example 5 | Example 6 | Example 7 | Example 8 |
|---|---|---|---|---|---|---|---|---|---|
| SiO₂ | | 83.0 | 66.1 | 81.0 | 64.0 | 67.0 | 71.0 | 64.6 | 67.0 |
| B₂O₃ | | 12.0 | 7.3 | 11.5 | 7.5 | 19.5 | 0.0 | 0.0 | 4.0 |
| Al₂O₃ | | 1.0 | 11.2 | 3.5 | 13.0 | 6.5 | 1.0 | 8.0 | 13.0 |
| MgO | | 0.0 | 5.4 | 0.0 | 6.5 | 0.7 | 6.5 | 10.0 | 2.2 |
| CaO | | 0.0 | 5.0 | 0.0 | 5.5 | 5.0 | 8.3 | 0.3 | 0.0 |
| SrO | | 0.0 | 5.0 | 0.0 | 3.5 | 0.1 | 0.0 | 0.1 | 0.0 |
| BaO | | 0.0 | 0.0 | 0.0 | 0.0 | 0.0 | 0.0 | 0.0 | 0.0 |
| ZnO | | 0.0 | 0.0 | 0.0 | 0.0 | 0.0 | 0.0 | 0.0 | 0.0 |
| ZrO₂ | | 0.0 | 0.0 | 0.0 | 0.0 | 0.2 | 0.0 | 0.5 | 0.0 |
| Li₂O | | 0.0 | 0.0 | 1.0 | 0.0 | 0.0 | 0.0 | 0.0 | 0.0 |
| Na₂O | | 2.0 | 0.0 | 1.0 | 0.0 | 1.0 | 13.0 | 12.5 | 13.6 |
| K₂O | | 2.0 | 0.0 | 2.0 | 0.0 | 0.0 | 0.2 | 4.0 | 0.2 |
| TiO₂ | | 0.0 | 0.0 | 0.0 | 0.0 | 0.0 | 0.0 | 0.0 | 0.0 |
| Y₂O₃ | | 0.0 | 0.0 | 0.0 | 0.0 | 0.0 | 0.0 | 0.0 | 0.0 |
| Total | | 100.0 | 100.0 | 100.0 | 100.0 | 100.0 | 100.0 | 100.0 | 100.0 |
| SiO₂ + B₂O₃ + AI₂O₃ | | 96.0 | 84.6 | 96.0 | 84.5 | 93.0 | 72.0 | 72.6 | 84.0 |
| Vickers | Presence or | Yes | No | Yes | No | No | Yes | Yes | No |
| indentation | absence of | | | | | | | | |
| (5 \|N\|) | cracks | | | | | | | | |
| | c/l | 0.33 | — | 0.38 | — | — | 0.70 | 0.59 | — |
| Expression | α (k⁻¹) | 3.25 × 10⁻⁶ | 3.80 × 10⁻⁶ | 3.70 × 10⁻⁶ | 4.00 × 10⁻⁶ | 3.30 × 10⁻⁶ | 8.50 × 10⁻⁶ | 9.50 × 10⁻⁶ | 7.50 × 10⁻⁶ |
| (1) | E (MPa) | 64 × 10³ | 76 × 10³ | 67 × 10³ | 80 × 10³ | 60 × 10³ | 73 × 10³ | 74 × 10³ | 69 × 10³ |
| | K_{IC} (MPa · m^{1/2}) | 0.65 | 0.87 | 0.68 | 0.88 | 0.62 | 0.74 | 0.68 | 0.74 |
| | a (m) | 500 × 10⁻⁶ to 2000 × 10⁻⁶ | | | | | | | |
| | ΔT [° C.] | 35 | 35 | 35 | 35 | 35 | 35 | 35 | 35 |
| | Sufficiency | A | A | A | A | A | B | B | B |
| | regarding | | | | | | | | |
| | expression (1) | | | | | | | | |

In the glass plates in Example 1 to Example 5, no cracks were generated in the Vickers indentation, or even when cracks were generated, c/l was less than 0.50. In addition, the glass plates in Example 1 to Example 5 all satisfied the expression (1). The above results showed that the glass plates in Example 1 to Example 5 had high strength and high resistance to cracks when a surface temperature difference occurred on both surfaces of the glass plate.

On the other hand, in the glass plates in Example 6 and Example 7, cracks were generated in the Vickers indentation, and c/l was 0.50 or more. In addition, the glass plates in Example 6 and Example 7 did not satisfy the expression (1). Further, in the glass plate in Example 8, although no cracks were generated in the Vickers indentation, it did not satisfy the expression (1).

Although various embodiments have been described above with reference to the drawings, it is needless to say that the present invention is not limited to such examples. It is obvious for a person skilled in the art that various modifications and variations can be made within the category described in the scope of claims and it is understood that such modifications and variations naturally belong to the technical scope of the present invention. Further, the components described in the above embodiment may be combined in any manner without departing from the spirit of the invention.

Note that the present application is based on Japanese Patent Application No. 2021-175914 filed on Oct. 27, 2021, contents of which are incorporated herein by reference.

### REFERENCE SIGNS LIST

10 laminated glass
11 first glass plate
12 second glass plate
13 interlayer
100 vehicle
110 opening
120 housing
150 back mirror
201 millimeter wave radar
202 stereo camera
300 radio wave

1. A glass plate, comprising:
a glass plate having a first surface and a second surface facing the first surface,
wherein when a Vickers indentation is performed with a force of 5 N on the first surface or the second surface, no cracks are generated, or c/l<0.50 where c in mm is an average length of a generated crack in a plan view of the first surface or the second surface and 1 mm is an average length that is half of a diagonal of an indentation, and when a fracture toughness value is K_{IC} in MPa·m^{1/2}, a crack length is a m, a Young's modulus is E MPa, an average thermal expansion coefficient at 20° ° C. to 300° C. is αK⁻¹, and a temperature difference between a temperature T_{S1} on a first surface side and a temperature T_{S2} on a second surface side is ΔT ° C., expression (1) is satisfied under conditions of 500×10⁻⁶ m≤a≤2000×10⁻⁶ m and 20≤ΔT≤45,
$$\frac{{K}_{IC}}{\sqrt{π a}} > E α Δ T . \qquad ( 1 )$$

2. The glass plate according to claim 1, wherein the glass plate has a composition comprising, in mol % in terms of oxide, 60.0%≤SiO₂≤90.0%, 0.0%≤B₂O₃≤25.0%, 0.0%≤Al₂O₃≤15.0%, 0.0%≤MgO≤15.0%, 0.0%≤CaO≤10.0%, 0.0%≤SrO≤10.0%, 0.0%≤BaO≤5.0%, 0.0%≤Li₂O≤10.0%, 0.0%≤Na₂O≤10.0%, and 0.0%≤K₂O≤10.0%.

3. The glass plate according to claim 2, wherein the composition of the glass plate has, in mol % in terms of oxide, 1.0%≤B₂O₃≤20.0%.

4. The glass plate according to claim 2, wherein the composition of the glass plate has a total amount of SiO₂, B₂O₃ and Al₂O₃ that is 80.0% or more in mol % in terms of oxide.

5. The glass plate according to claim 1, wherein the glass plate has a composition comprising, in mol % in terms of oxide, 60.0%≤SiO₂≤90.0%, 1.0%≤B₂O₃≤20.0%, 0.0%≤Al₂O₃≤2.0%, 0.0%≤MgO≤15.0%, 0.0%≤CaO≤10.0%, 0.0%≤SrO≤10.0%, 0.0%≤BaO≤5.0%, 0.0%≤Li₂O≤10.0%, 0.0%≤Na₂O≤3.0%, and 0.0%≤ K₂O≤10.0% such that a total amount of SiO₂, B₂O₃ and Al₂O₃ is 80.0% or more in mol % in terms of oxide.

6. The glass plate according to claim 1, wherein the glass plate has a composition comprising, in mol % in terms of oxide, 60.0%≤SiO₂≤90.0%, 1.0%≤B₂O₃≤20.0%, 0.0%≤Al₂O₃≤15.0%, 0.0%≤MgO≤15.0%, 0.0%≤CaO≤10.0%, 0.0%≤SrO≤10.0%, 0.0%≤BaO≤5.0%, 0.0%≤ Li₂O≤10.0%, 0.0%≤ Na₂O≤3.0%, and 0.0%≤K₂O≤10.0% such that a total amount of SiO₂, B₂O₃ and Al₂O₃ is 80.0% or more in mol % in terms of oxide and a total amount of Li₂O, Na₂O, K₂O, MgO, CaO, SrO and BaO is 1.0% or more and 7.5% or less in mol % in terms of oxide.

7. The glass plate according to claim 2, wherein the glass plate comprises iron in a content of 500 ppm by mass or less.

8. The glass plate according to claim 1, wherein the average thermal expansion coefficient at 20° ° C. to 300° ° C. is 5.0×10⁻⁶ K⁻¹ or less.

9. The glass plate according to claim 1, further comprising:
an infrared reflection film positioned on or above the glass plate.

10. The glass plate according to claim 1, wherein the glass plate has a thickness of 2.0 mm or more.

11. The glass plate according to claim 10, wherein the thickness of the glass plate is 3.0 mm or more.

12. A window glass for a vehicle, comprising:
the glass plate of claim 1.

13. A laminated glass, comprising:
a first glass plate;
a second glass plate; and
an interlayer positioned between the first glass plate and the second glass plate,
wherein the first glass plate is configured to be positioned on a vehicle-exterior side when the laminated glass is attached to a vehicle, and the first glass plate includes the glass plate of claim 1.

14. The laminated glass according to claim 13, wherein the second glass plate includes the glass plate of claim 1.

15. A windshield, comprising:
the laminated glass of claim 13.

16. The glass plate according to claim 2, wherein the average thermal expansion coefficient at 20° ° C. to 300° ° C. is 5.0×10⁻⁶ K⁻¹ or less.

17. The glass plate according to claim 2, further comprising:
an infrared reflection film positioned on or above the glass plate.

18. The glass plate according to claim 2, wherein the glass plate has a thickness of 2.0 mm or more.

19. The glass plate according to claim 3, wherein the average thermal expansion coefficient at 20° ° C. to 300° C. is 5.0×10⁻⁶ K⁻¹ or less.

20. The glass plate according to claim 3, further comprising:
an infrared reflection film positioned on or above the glass plate.
